(19) United States
(12) Patent Application Publication
(10) Pub. No.: US 2007/0108182 A1
(43) Pub. Date: May 17, 2007

(54) Food cooking device with food weight measuring device

(76) Inventor: Wen-Ching Lee, Taipei (TW)

Correspondence Address: Wen-Ching LEE, P.O. Box 44 - 2049, Taipei, 10668, TW

(21) Appl. No.: 11/594,792

(22) Filed: Nov. 9, 2006

(30) Foreign Application Priority Data
Nov. 11, 2005 (TW) 094139626

(51) Int. Cl. F27D 11/00

(52) U.S. Cl. 219/400

(57) ABSTRACT

The present invention relates to a food cooking device and includes a weight measuring device connected to the body of the food cooking device so as to provide the controller of the food cooking device information of the food to be treated. The food cooking device has a controller received therein and a control panel is electrically connected with the controller. A plurality of food catalogue buttons are installed on the control panel. The controller sets the body to a cooking mold according to input commands from the weight measuring device and one of the food catalogue buttons.

### BACKGROUND OF THE INVENTION

(1) Field of the Invention

The present invention relates to an electric food cooking device electrically connected with a weigh measuring device which provide the weight of the food to be treated so that the food cooking device treats the food properly.

(2) Description of the Prior Art

Conventional electric food cooking devices such as microwave ovens, broilers, or toaster ovens generally include a control panel on which several buttons are attached, users input the proper temperature and cooking time according to the quantity and type of the food to be cooked. In other words, different types of food require different settings to the temperature and cooking time. However, some users do not able to set the input commands correctly so that the food cannot be cooked as expected.

Therefore, the inventor of the present invention develops a weight measuring device connected to the food cooking device wherein the user simply inputs the weight of the food to be treated, the food cooking device automatically sets a proper cooking mold according the weight of the food.

### SUMMARY OF THE INVENTION

The present invention relates to a food cooking device and includes a body having a controller received therein and a control panel being electrically connected with the controller. A plurality of food catalogue buttons are installed on the control panel. A weight measuring device is connected to the controller which sets the body to a cooking mold according to input commands from the weight measuring device and one of the food catalogue buttons.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of a first embodiment of the combination of the food cooking device and weight measuring device of the present invention;

FIG. 2 is a perspective view of a second embodiment of the combination of the food cooking device and weight measuring device of the present invention;

FIG. 3 shows that the weight measuring device is connected to the food cooking device by a wire, and

FIG. 4 shows that the weight measuring device and the food cooking device are two separated devices.

### DETAILED DESCRIPTION OF THE PREFERRED EMBODIMENTS

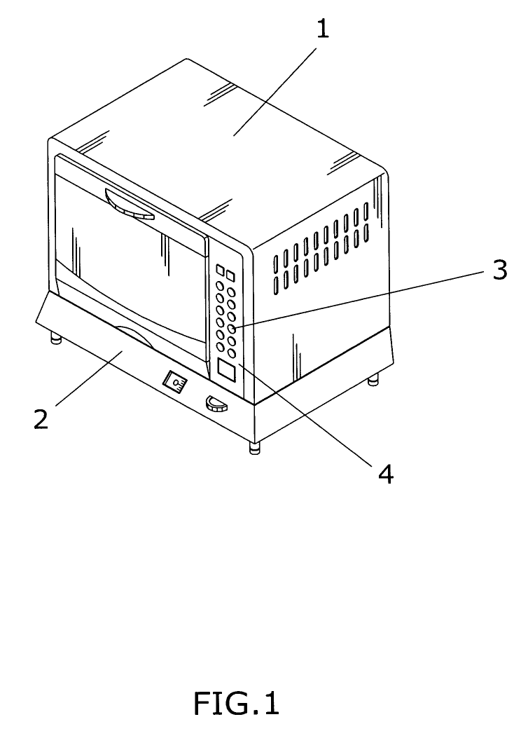

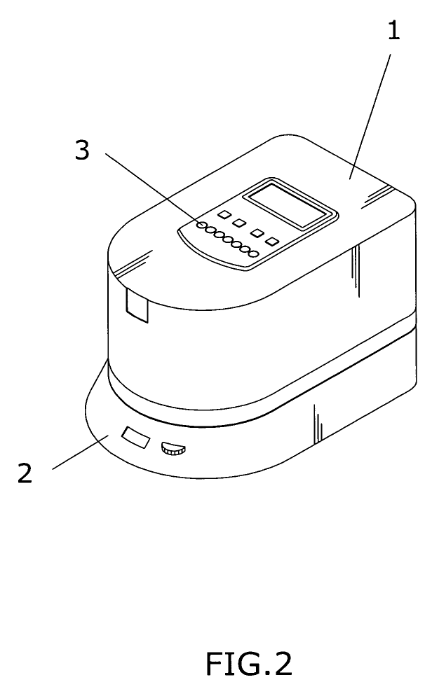

Referring to FIGS. 1 and 2, the food cooking device of the present invention comprises a body 1 having a heating unit and a controller (both not shown) and a control panel 4 being electrically connected with the controller. A plurality of food catalogue buttons 3 are installed on the control panel 4. The food cooking device can be a microwave oven or a broiler. A weight measuring device 2 is connected to the controller. The weight measuring device 2 is connected to an underside of the body 1 so that when the user put the food in the body 1, the weight measuring device 2 measures the weight of the food. The weight of the food is then sent to the controller and the user operates the food catalogue buttons 3 to input the type of food to the controller so that the controller sets the food cooking device a proper cooking mold according to input commands. The food cooking device then cooks the food by a proper method.

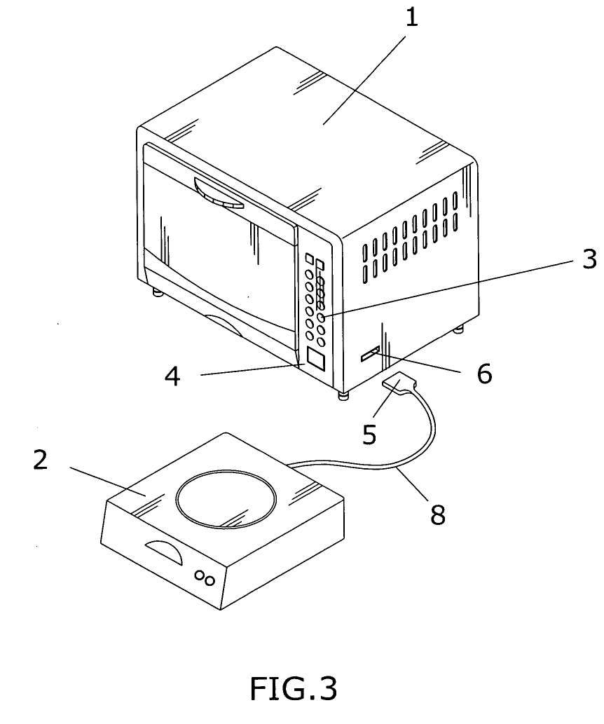

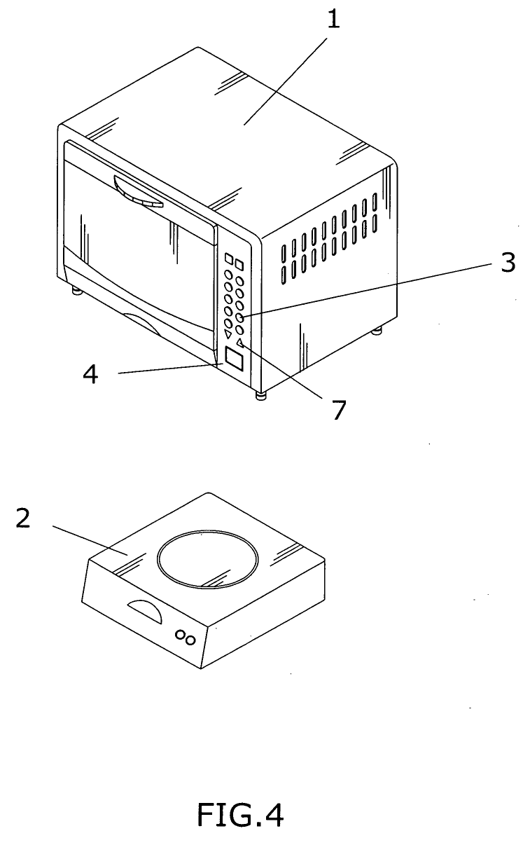

As shown in FIG. 3, the weight measuring device 2 can be connected to the body 1 by a wire 8 which has a plug 5 and the body 1 has a receptacle 6 with which the plug 5 is connected. As shown in FIG. 4, the weight measuring device 2 and the body 1 can be two separated devices and at least one weight input button 7 is installed on the control panel 4 so that user has to use the at least one weight input button 7 to input the data of the weight of the food to the controller.

By the combination of the present invention, the users need not to have experienced skill to set the cooking mold and simply input the weight of the food and the type of the food, the cooking mold can be properly set by the controller of the food cooking device.

While we have shown and described the embodiment in accordance with the present invention, it should be clear to those skilled in the art that further embodiments may be made without departing from the scope of the present invention.

What is claimed is:

1. A food cooking device comprising:
a body having a controller and a control panel electrically connected with the controller, a plurality of food catalogue buttons installed on the control panel, and
a weight measuring device connected to the controller which sets the body to a cooking mold according to input commands from the weight measuring device and one of the food catalogue buttons.

2. The device as claimed in claim 1, wherein the weight measuring device is connected to an underside of the body.

3. The device as claimed in claim 1, wherein the weight measuring device is connected to an underside of the body by a wire.

4. The device as claimed in claim 3, wherein a plug is connected to the wire and the body has a receptacle with which the plug is connected.

5. The device as claimed in claim 1, wherein at least one weight input button is installed on the control panel.
